(19) United States
(12) Patent Application Publication
(10) Pub. No.: US 2005/0238354 A1
(43) Pub. Date: Oct. 27, 2005

(54) System, method, and product for increased signal and reduced noise detection

(75) Inventors: Albert K. Bukys, Lexington, MA (US); Peter E. Joyce, Santa Clara, CA (US); John A. Mundaden, Fremont, CA (US)

Correspondence Address: AFFYMETRIX, INC;ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA (US)

(21) Appl. No.: 11/114,376

(22) Filed: Apr. 26, 2005

Related U.S. Application Data
(60) Provisional application No. 60/565,442, filed on Apr. 26, 2004.

(51) Int. Cl. H04J 14/00

(52) U.S. Cl. 398/48

(57) ABSTRACT

A probe array product is described that comprises a substrate that includes a plurality of biological probes disposed thereon, where at least one of the biological probes is enabled to hybridize a target molecule that comprises a detectable label; and a coating disposed upon a first surface of the substrate, where the coating is substantially reflective at a first wavelength range and is substantially transmissive at a second wavelength range.

### RELATED APPLICATIONS

The present application claims priority to U.S. Provisional Application Ser. No. 60/565,442, titled “System and Method for Increased Light Collection”, filed Apr. 26, 2004, which is hereby incorporated by reference herein in its entirety for all purposes.

### FIELD OF THE INVENTION

The present invention relates to systems, methods, and products enabled to increase the efficiency of the collection of emitted light from one or more labels associated with target molecules and hybridized to probes on a biological probe array while reducing background effects produced by excitation light. In particular, the present invention relates to systems, methods, and products that provide a coating that is substantially reflective to the wavelengths of emitted light and substantially transmissive to the wavelengths of excitation light.

### BACKGROUND

Synthesized nucleic acid probe arrays, such as Affymetrix GeneChip® probe arrays, and spotted probe arrays, have been used to generate unprecedented amounts of information about biological systems. For example, the GeneChip® Human Genome U133 Plus 2.0 array available from Affymetrix, Inc. of Santa Clara, Calif., is comprised of a single microarray containing over 1,000,000 unique oligonucleotide features covering more than 47,000 transcripts that represent more than 33,000 human genes. Analysis of expression data from such microarrays may lead to the development of new drugs and new diagnostic tools.

As probe features become increasingly smaller and to provide single molecule sensitivity the need exists for an improved ability to efficiently collect emitted light associated with target molecules hybridized to probes and reduce the sources of background noise. One way to accomplish this is to selectively reflect the wavelengths of light associated with the probe/target pairs such as, for instance, reflecting emitted photons of fluorescent light towards one or more detection and/or optical elements that otherwise would not be directed to them, while simultaneously selectively allowing wavelengths of light associated with an range of excitation light to transmissively pass through a substrate on which the probe/target pairs are disposed effectively directing such range of wavelengths away from the one or more detection and/or optical elements.

### SUMMARY OF THE INVENTION

The expanding use of microarray technology is one of the forces driving the development of high throughput instruments and technology. In particular, microarrays and associated instrumentation and computer systems have been developed for rapid and large-scale collection of data about the expression of genes or expressed sequence tags (EST's), as well as determination of the sequence composition of nucleic acids. Microarray technology and associated instrumentation and computer systems employ a variety of methods to obtain accurate data from microarray experiments. Scanning each array is an essential step in microarray experiments and relies, amongst numerous other factors, on the ability to effectively resolve small and/or dim probe features from background noise effects.

In one embodiment, a probe array product is described that comprises a substrate that includes a plurality of biological probes disposed thereon, where at least one of the biological probes is enabled to hybridize a target molecule that comprises a detectable label; and a coating disposed upon a first surface of the substrate, where the coating is substantially reflective at a first wavelength range and is substantially transmissive at a second wavelength range.

In some implementations, the plurality of biological probes are disposed on the first surface, where the coating is disposed between the substrate and the biological probes, and the detectable label emits a first wavelength within the first wavelength range in response to a second wavelength in the second wavelength range. In addition, some embodiments may include one or more optical elements that collect a first fraction and a second fraction of the first wavelength, where the first fraction is emitted within a collection area of at least one of the optical elements and the second fraction is emitted and reflected into the collection area, as well as one or more detectors optically coupled to the one or more optical elements that produce a detected signal responsive to the collected first and second fractions of the first wavelength.

Also, a system for increased signal detection is described that comprises a substrate that includes a plurality of biological probes disposed thereon, where at least one of the biological probes is enabled to hybridize a target molecule that comprises a detectable label that emits a first wavelength in response to a second wavelength; a coating disposed upon a first surface of the substrate, where the coating is substantially reflective at a first wavelength range and is substantially transmissive at a second wavelength range; and a scanner that comprises a source that provides the second wavelength; one or more optical elements that collect a first and a second fraction of the first wavelength; and one or more detectors optically coupled to the one or more optical elements that produce a detected signal responsive to the collected first and second fractions of the first wavelength, where the second fraction provides an increase of the detected signal from the first wavelength.

Additionally, a method for increased signal detection is described that comprises directing a first wavelength at a detectable label that emits a second wavelength in response to the first wavelength; transmitting the first wavelength away from a collection area; reflecting a first fraction of the second wavelength into the collection area; collecting the first fraction and a second fraction of the second wavelength from the collection area, wherein the second fraction comprises emission within the collection area; and producing a detected signal responsive to the collected first and second fractions, wherein the first fraction provides an increased magnitude of the detected signal.

The above implementations are not necessarily inclusive or exclusive of each other and may be combined in any manner that is non-conflicting and otherwise possible, whether they be presented in association with a same, or a different, aspect or implementation. The description of one implementation is not intended to be limiting with respect to other implementations. Also, any one or more function, step, operation, or technique described elsewhere in this specification may, in alternative implementations, be combined with any one or more function, step, operation, or technique described in the summary. Thus, the above implementations are illustrative rather than limiting.

### BRIEF DESCRIPTION OF THE DRAWINGS

The above and further advantages will be more clearly appreciated from the following detailed description when taken in conjunction with the accompanying drawings. In the drawings, like reference numerals indicate like structures or method steps and the leftmost one or two digits of a reference numeral indicate the number of the figure in which the referenced element first appears (for example, the element 100 appears first in FIG. 1). In functional block diagrams, rectangles generally indicate functional elements, parallelograms generally indicate data, rectangles with curved sides generally indicate stored data, rectangles with a pair of double borders generally indicate predefined functional elements, and keystone shapes generally indicate manual operations. In method flow charts, rectangles generally indicate method steps and diamond shapes generally indicate decision elements. All of these conventions, however, are intended to be typical or illustrative, rather than limiting.

FIG. 1 is a functional block diagram of one embodiment of a computer system that provides instrument control to a scanner instrument and a probe array;

FIG. 2A is a simplified graphical representation of one embodiment of an objective lens of the scanner and probe array of FIG. 1 having a characteristic focus/collection area boundary;

FIG. 2B is a simplified graphical representation of one embodiment of the focus/collection area boundary and probe array of FIG. 2A having a hybridized probe target pair and associated label emitting light in response to an excitation beam; and

FIG. 3 is a simplified graphical representation of one embodiment of the probe array of FIGS. 1, 2A, and 2B having a coating that is substantially reflective to emitted light, and substantially transmissive to the excitation beam.

### DETAILED DESCRIPTION OF THE INVENTION

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, N.Y., Gait, “Oligonucleotide Synthesis: A Practical Approach” 1984, IRL Press, London, Nelson and Cox (2000), Lehninger, Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), 09/910,292 (U.S. Patent Application Publication 20030082543), and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. 20020183936), 10/065,856, 10/065,868, 10/328,818, 10/328,872, 10/423,403, and 60/482,389.

b) Definitions

The term “array” as used herein refers to an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

The term “biomonomer” as used herein refers to a single unit of biopolymer, which can be linked with the same or other biomonomers to form a biopolymer (for example, a single amino acid or nucleotide with two linking groups one or both of which may have removable protecting groups) or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers.

The term “biopolymer” or “biological polymer” as used herein is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above.

The term “biopolymer synthesis” as used herein is intended to encompass the synthetic production, both organic and inorganic, of a biopolymer. Related to a bioploymer is a “biomonomer”.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “combinatorial synthesis strategy” as used herein refers to a combinatorial synthesis strategy is an ordered strategy for parallel synthesis of diverse polymer sequences by sequential addition of reagents which may be represented by a reactant matrix and a switch matrix, the product of which is a product matrix. A reactant matrix is a 1 column by m row matrix of the building blocks to be added. The switch matrix is all or a subset of the binary numbers, preferably ordered, between 1 and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

The term “complex population or mixed population” as used herein refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (rRNA).

The term “effective amount” as used herein refers to an amount sufficient to induce a desired result.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization conditions” as used herein will typically include salt concentrations of less than about 1M, more usually less than about 500 mM and preferably less than about 200 mM. Hybridization temperatures can be as low as 5.degree. C., but are typically greater than 22.degree. C., more typically greater than about 30.degree. C., and preferably in excess of about 37.degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

The term “hybridization” as used herein refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2nd Ed. Cold Spring Harbor Press (1989) which is hereby incorporated by reference in its entirety for all purposes above.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5×SSPE) and a temperature of from about 25 to about 30° C.

The term “hybridization probes” as used herein are oligonucleotides capable of binding in a base-specific manner to a complementary strand of nucleic acid. Such probes include peptide nucleic acids, as described in Nielsen et al., Science 254, 1497-1500 (1991), LNAs, as described in Koshkin et al. Tetrahedron 54:3607-3630, 1998, and U.S. Pat. No. 6,268,490, aptamers, and other nucleic acid analogs and nucleic acid mimetics.

The term “hybridizing specifically to” as used herein refers to the binding, duplexing, or hybridizing of a molecule only to a particular nucleotide sequence or sequences under stringent conditions when that sequence is present in a complex mixture (e.g., total cellular) DNA or RNA.

The term “initiation biomonomer” or “initiator biomonomer” as used herein is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

The term “isolated nucleic acid” as used herein mean an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

The term “ligand” as used herein refers to a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

The term “linkage disequilibrium or allelic association” as used herein refers to the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

The term “mixed population” as used herein refers to a complex population.

The term “monomer” as used herein refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

The term “mRNA” or “mRNA transcripts” as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The term “nucleic acid library or array” as used herein refers to an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “oligonucleotide” or “polynucleotide” as used herein refers to a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “probe” as used herein refers to a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The term “primer” as used herein refers to a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

The term “polymorphism” as used herein refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. Single nucleotide polymorphisms (SNPs) are included in polymorphisms.

The term “receptor” as used herein refers to a molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

### c) Embodiments of the Present Invention

Embodiments of the invention for selectively reflecting light of a first range of wavelengths towards one or more optical and/or detector elements of a detection instrument while simultaneously transmitting light of a second range of wavelengths effectively allowing or directing the second range of wavelengths away from the one or more optical and/or detector elements are described herein that provides for better resolution that is particularly advantageous for very small and/or dim features disposed upon a substrate. For instance, embodiments are described that comprise one or more coatings on a substrate that provide for selectivity of the ranges of wavelengths to reflect and transmit.

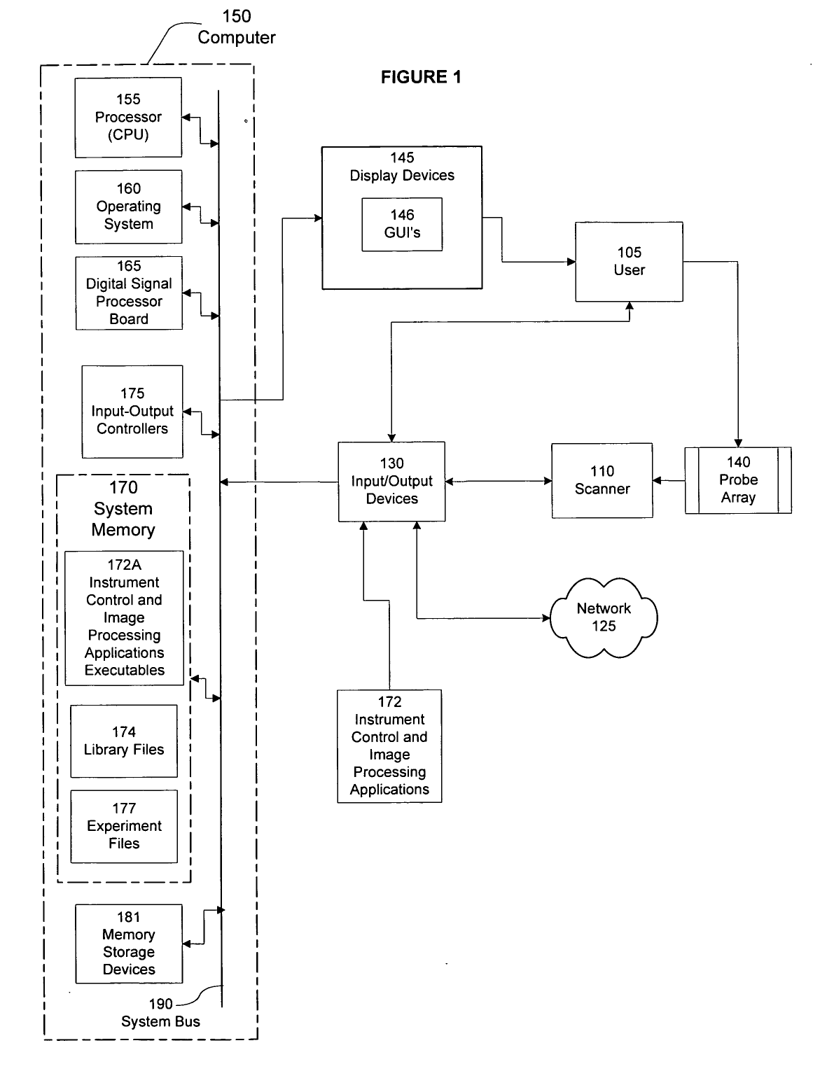

Computer 150: An illustrative example of computer 150 is provided in FIG. 1. Computer 150 may be any type of computer platform such as a workstation, a personal computer, a server, or any other present or future computer. Computer 150 typically includes known components such as a processor 155, an operating system 160, system memory 170, memory storage devices 181, and input-output controllers 175, input-output devices 130, and display devices 145. Display Devices 145 may include display devices that provides visual information, this information typically may be logically and/or physically organized as an array of pixels. A Graphical user interface (GUI) controller may also be included that may comprise any of a variety of known or future software programs for providing graphical input and output interfaces such as for instance GUI's 146. For example, GUI's 146 may provide one or more graphical representations to a user, such as user 105, and also be enabled to process user inputs via GUI's 146 using means of selection or input known to those of ordinary skill in the related art.

It will be understood by those of ordinary skill in the relevant art that there are many possible configurations of the components of computer 150 and that some components that may typically be included in computer 150 are not shown, such as cache memory, a data backup unit, and many other devices. Processor 155 may be a commercially available processor such as an Itanium® or Pentium® processor made by Intel Corporation, a SPARC® processor made by Sun Microsystems, an Athalon™ or Opteron™ processor made by AMD corporation, or it may be one of other processors that are or will become available. Processor 155 executes operating system 160, which may be, for example, a Windows®-type operating system (such as Windows NT® 4.0 with SP6a, or Windows® XP) from the Microsoft Corporation; a Unix® or Linux-type operating system available from many vendors or what is referred to as an open source; another or a future operating system; or some combination thereof. Operating system 160 interfaces with firmware and hardware in a well-known manner, and facilitates processor 155 in coordinating and executing the functions of various computer programs that may be written in a variety of programming languages. Operating system 160, typically in cooperation with processor 155, coordinates and executes functions of the other components of computer 150. Operating system 160 also provides scheduling, input-output control, file and data management, memory management, and communication control and related services, all in accordance with known techniques.

System memory 170 may be any of a variety of known or future memory storage devices. Examples include any commonly available random access memory (RAM), magnetic medium such as a resident hard disk or tape, an optical medium such as a read and write compact disc, or other memory storage device. Memory storage devices 181 may be any of a variety of known or future devices, including a compact disk drive, a tape drive, a removable hard disk drive, USB drive, or a diskette drive. Such types of memory storage devices 181 typically read from, and/or write to, a program storage medium (not shown) such as, respectively, a compact disk, magnetic tape, removable hard disk, USB drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 170 and/or the program storage device used in conjunction with memory storage device 181.

In some embodiments, a computer program product is described comprising a computer usable medium having control logic (computer software program, including program code) stored therein. The control logic, when executed by processor 155, causes processor 155 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 175 could include any of a variety of known devices for accepting and processing information from a user, whether a human or a machine, whether local or remote. Such devices include, for example, modem cards, network interface cards, sound cards, or other types of controllers for any of a variety of known input devices. Output controllers of input-output controllers 175 could include controllers for any of a variety of known display devices for presenting information to a user, whether a human or a machine, whether local or remote. In the illustrated embodiment, the functional elements of computer 150 communicate with each other via system bus 190. Some of these communications may be accomplished in alternative embodiments using network or other types of remote communications.

As will be evident to those skilled in the relevant art, an instrument control and image processing application, such as for instance an implementation of instrument control and image processing applications 172, if implemented in software, may be loaded into and executed from system memory 170 and/or memory storage device 181. All or portions of the instrument control and image processing applications may also reside in a read-only memory or similar device of memory storage device 181, such devices not requiring that the instrument control and image processing applications first be loaded through input-output controllers 175. It will be understood by those skilled in the relevant art that the instrument control and image processing applications, or portions of it, may be loaded by processor 155 in a known manner into system memory 170, or cache memory (not shown), or both, as advantageous for execution. Also illustrated in FIG. 1 are library files 174, and experiment data 177 stored in system memory 170. For example, experiment data 177 could include data related to one or more experiments or assays such as excitation wavelength ranges, emission wavelength ranges, extinction coefficients and/or associated excitation power level values, or other values associated with one or more fluorescent labels.

Network 125 may include one or more of the many various types of networks well known to those of ordinary skill in the art. Network 125 may include what is commonly referred to as a TCP/IP network, or other type of network that may include the internet, or intranet architectures. For example, network 125 may include a local area network, a wide area network, the Internet, another network, or any combination thereof.

Instrument control and image processing applications 172: Instrument control and image processing applications 172 may be any of a variety of known or future image processing applications. Examples of applications 172 include Affymetrix® Microarray Suite, Affymetrix® GeneChip® Operating Software (hereafter referred to as GCOS), and Affymetrix® Jaguar™ software, noted above. Applications 172 may be loaded into system memory 170 and/or memory storage device 181 through one of input devices 130.

Embodiments of applications 172 include executable code being stored in system memory 170, illustrated in FIG. 1 as instrument control and analysis applications executables 172A. Applications 172 may provide a modular interface for one or more computers or workstations and one or more servers, as well as one or more instruments. In the presently described implementation, the interface may communicate with and control one or more elements of the one or more servers, one or more workstations, and the one or more instruments. In the described implementation the server or computer 150 or workstation with an implementation of applications 172 could be located locally or remotely to the one or more servers and/or one or more other computers or workstations.

The interface may, in the present implementation, include an interactive graphical user interface that allows a user to make selections based upon information presented in an embodiment of GUI 146. Also, embodiments of GUI 146 may be written in an HTML, XHTML, XML, javascript, Jscript, or other language known to those of ordinary skill in the art used for the creation of enhancement of “Web Pages” viewable and compatible with various internet browsers such as Internet Explorer, Netscape Navigator, Mozilla Firefox, or other browsers known in the art. Applications of GUI's 146 viewable via one or more internet type browsers may alow user 101 complete remote access to data, management, and registration functions without any other specialized software elements. Applications 172 may provide one or more implementation of GUI's 146 that are interactive allowing user 105 to select from a variety of options including data selection, experiment parameters, calibration values, and probe array information within the access to data, management, and registration functions.

Applications 172 may also provide a graphical representation of raw or processed image data where the processed image data may also include annotation information superimposed upon the image such as, for instance, base calls, features of the probe array, or other useful annotation information. Further examples of providing annotation information on image data are provided in U.S. Provisional Patent Application Ser. No. 60/493,950, titled “System, Method, and Product for Displaying Annotation Information Associated with Microarray Image Data”, filed Aug. 8, 2003, which is hereby incorporated by reference herein in its entirety for all purposes.

Embodiments of applications 172 also include instrument control features, where the control functions of individual types or specific instruments such as scanner 110, what may be referred to as an autoloader, or fluid handling system may be organized as plug-in type modules to applications 172. For example, each plug-in module may be a separate component that is functionally integrated with executables 172A when stored in system memory 170. The instrument control features may include the control of one or more elements of one or more instruments that could, for instance, include elements of the fluid handling system, the autoloader, and scanner 110. The instrument control features may also be capable of receiving information from the one more instruments that could include experiment or instrument status, process steps, or other relevant information. The instrument control features could, for example, be under the control of or an element of the interface of applications 172. In the present example, a user may input desired control commands and/or receive the instrument control information via one of GUI's 146. Additional examples of instrument control via a GUI or other interface is provided in U.S. patent application Ser. No. 10/764,663, titled “System, Method and Computer Software Product for Instrument Control, Data Acquisition, Analysis, Management and Storage”, filed Jan. 26, 2004, which is hereby incorporated by reference herein in its entirety for all purposes.

In some embodiments, image data is acquired from scanner 110 and operated upon by applications 172 to generate intermediate results. Examples of intermediate results include so-called cell intensity files (*.cel) and chip files (*.chp) generated by Affymetrix® GeneChip® Operating Software or Affymetrix® Microarray Suite (as described, for example, in U.S. patent application Ser. Nos. 10/219,882, and 10/764,663, both of which are hereby incorporated herein by reference in their entireties for all purposes) and spot files (*.spt) generated by Affymetrix® Jaguar™ software (as described, for example, in PCT Application PCT/US 01/26390 and in U.S. patent application Ser. Nos. 09/681,819, 09/682,071, 09/682,074, and 09/682,076, all of which are hereby incorporated by reference herein in their entireties for all purposes). For convenience, the term “file” often is used herein to refer to data generated or used by applications 172 and executable counterparts of other applications, but any of a variety of alternative techniques known in the relevant art for storing, conveying, and/or manipulating data may be employed.

For example, applications 172 receive image data derived from probe array 140 and generates a cell intensity file. This file contains, for each probe feature scanned by scanner 110, a single value representative of the intensities of pixels measured by scanner 110 for that probe. For example, this value may include a measure of the abundance of tagged mRNA's present in the target that hybridized to the corresponding probe. Many such mRNA's may be present in each probe, as a probe on a GeneChip® probe array may include, for example, millions of oligonucleotides designed to detect the mRNA's. Alternatively, the value may include a measure related to the sequence composition of DNA or other nucleic acid detected by the probes of a GeneChip® probe array.

As noted, another file that may be generated by applications 172 is a chip file. For example, applications 172 may include Affymetrix® GeneChip® Operating Software where the chip file is derived from analysis of the cell file combined in some cases with information derived from lab data and/or library files 174 that specify details regarding the sequences and locations of probes and controls. The resulting data stored in the chip file includes degrees of hybridization, absolute and/or differential (over two or more experiments) expression, genotype comparisons, detection of polymorphisms and mutations, and other analytical results. In some alternative embodiments, applications 172 may be enabled to export .cel, .dat, or other files to third party software or allow access to such files by the third party software.

In another example, in which applications 172 includes Affymetrix® Jaguar™ software operating on image data from a spotted probe array, the resulting spot file includes the intensities of labeled targets that hybridized to probes in the array. Further details regarding cell files, chip files, and spot files are provided in U.S. patent application Ser. Nos. 09/682,074 incorporated by reference above, as well as 10/126,468; and 09/682,098; which are hereby incorporated by reference herein in their entireties for all purposes. As will be appreciated by those skilled in the relevant art, the preceding and following descriptions of files generated by applications 172 are exemplary only, and the data described, and other data, may be processed, combined, arranged, and/or presented in many other ways.

User 105 and/or automated data input devices or programs (not shown) may provide data related to the design or conduct of experiments. As one further non-limiting example related to the processing of an Affymetrix® GeneChip® probe array, the user may specify an Affymetrix catalogue or custom chip type (e.g., Human Genome U133 plus 2.0 chip) either by selecting from a predetermined list presented by GCOS or by scanning a bar code, Radio Frequency Identification (RFID), magnetic strip, or other means of electronic identification related to a chip to read its type. Applications 172 may associate the chip type with various scanning parameters stored in data tables or library files, such as library files 174 of computer 150, including the area of the chip that is to be scanned, the location of chrome borders or other features on the chip used for auto-focusing, the wavelength or intensity/power of excitation light to be used in reading the chip, post acquisition processing methods or applications, and so on. As noted, applications 172 may apply some of this data in the generation of intermediate results. For example, information about the dyes may be incorporated into determinations of relative expression.

Those of ordinary skill in the related art will appreciate that one or more operations of applications 172 may be performed by software or firmware associated with various instruments. For example, scanner 110 could include a computer that may include a firmware component that performs or controls one or more operations associated with scanner 110.

Scanner 110: Labeled targets hybridized to probe arrays may be detected using various devices, sometimes referred to as scanners, as described above with respect to methods and apparatus for signal detection. An illustrative device is shown in FIG. 1 as scanner 110. For example, scanners image the targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 110 provides a signal representing the intensities (and possibly other characteristics, such as color that may be associated with a detected wavelength) of the detected emissions or reflected wavelengths of light, as well as the locations on the substrate where the emissions or reflected wavelengths were detected. Typically, the signal includes intensity information corresponding to elemental sub-areas of the scanned substrate. The term “elemental” in this context means that the intensities, and/or other characteristics, of the emissions or reflected wavelengths from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions or reflected wavelengths were scanned. The pixel may also have another value representing another characteristic, such as color, positive or negative image, or other type of image representation. The size of a pixel may vary in different embodiments and could include a 2.5 μm, 1.5 μm, 1.0 μm, or sub-micron pixel size. Two examples where the signal may be incorporated into data are data files in the form *.dat or *.tif as generated respectively by Affymetrix® Microarray Suite (described in U.S. patent application Ser. No. 10/219,882, which is hereby incorporated by reference herein in its entirety for all purposes) or Affymetrix® GeneChip® Operating Software (described in U.S. patent application Ser. No. 10/764,663, which is hereby incorporated by reference herein in its entirety for all purposes) based on images scanned from GeneChip® arrays, and Affymetrix® Jaguar™ software (described in U.S. patent application Ser. No. 09/682,071, which is hereby incorporated by reference herein in its entirety for all purposes) based on images scanned from spotted arrays. Examples of scanner systems that may be implemented with embodiments of the present invention include U.S. patent application Ser. No. 10/389,194, 10/846,261, and 10/913,102 each of which are incorporated by reference above.

For example, embodiments of scanner 110 may include one or more optical elements such as lenses, beam splitters, mirrors, filters, or other optical elements known to those of ordinary skill in the related art for directing and/or conditioning light. In the present example, the one or more optical elements may serve to direct or optically couple elements together such as optically coupling and directing light from a collection lens element to one or more detectors that may include a photo multiplier tube (generally referred to as a PMT), a Charge Coupled Device (generally referred to as a CCD), a photodiode, or other detection device known to those of ordinary skill in the related art. For instance, the optical coupling of embodiments of scanner 110 may generally serve to direct a beam of light from a source in scanner 110, through the one or more optical elements to a target, and further to collect light from the target and direct it to the one or more detectors where the light from the target is optically coupled to the one or more detectors.

Probe Array 140: An illustrative example of probe array 140 is provided in FIG. 1. Descriptions of probe arrays are provided above with respect to “Nucleic Acid Probe arrays” and other related disclosure described above. In various implementations probe array 140 may be disposed in a cartridge or housing such as, for example, the GeneChip® probe array available from Affymetrix, Inc. of Santa Clara Calif.

Some embodiments may include a plurality of probe arrays 140 disposed in an array of arrays type of format that could for instance include an embodiment of probe array 140 placed or produced in each well of a 96 well plate or other type of well plate known to those of ordinary skill in the related art. Similarly probe array 140 may be placed in a cuvette, tube, or other fluid containment structure enabled to house a single embodiment of probe array 140. Also some embodiments could include a plurality of probe arrays 140 disposed or synthesized on a substrate or wafer where structures for fluidically isolating each embodiment of probe array 140 may be employed. Yet other embodiments could include one or more implementations of probe array 140 disposed upon a post, peg, or other type of raised feature. In each of the above described embodiments specific instruments and/or methods may be employed for processing, image acquisition, or other steps, for the particular embodiment employed. For example, it may be advantageous to scan an embodiment of probe array 140 from what may be referred to as the “back side” or non-probe side of the array where the excitation beam passes through the probe array substrate to reach the fluorescent label associated with a hybridized probe/target pair. Alternatively, in some embodiments it may be more advantageous to scan from what may be referred to as the “front side” or probe side of the substrate.

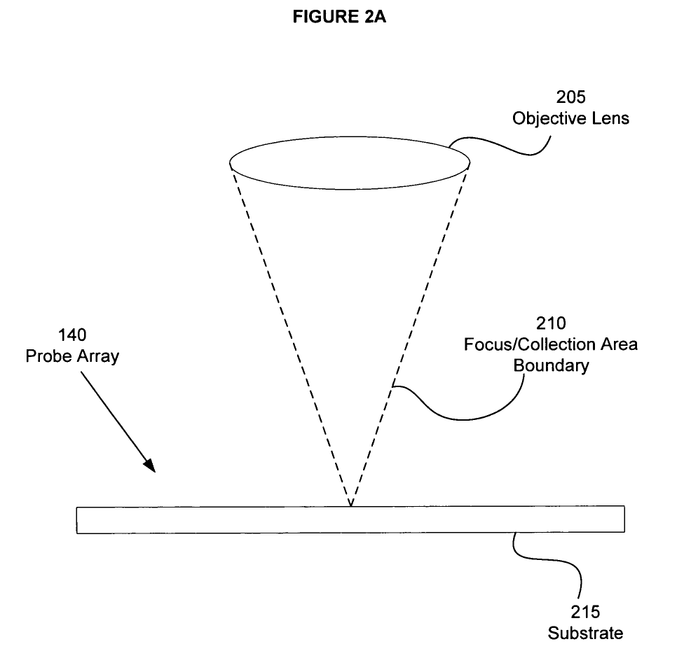

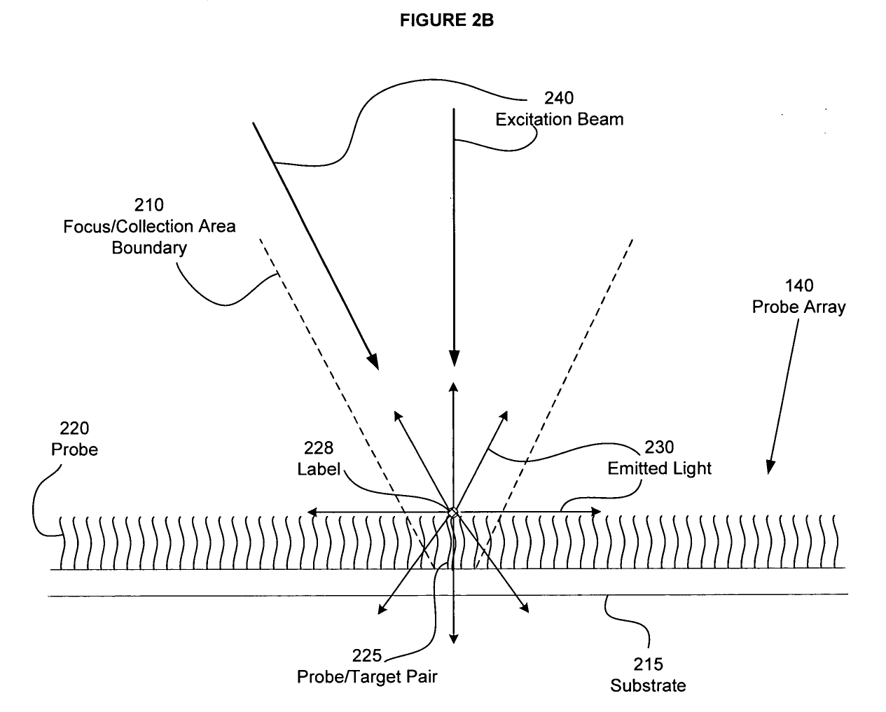

FIG. 2A provides an illustrative example of probe array 140 having substrate 215 and positioned with respect to an element of scanner 110 such as, for instance, objective lens 205. For example, those of ordinary skill in the related art will appreciate that objective lens 205 may include what is referred to as a high numerical aperture lens that generally refers to the lens' ability to focus and gather light from an area determined by the distance away from lens 205, where the high numerical aperture provides a wide cone such as that defined by focus/collection area boundary 210 that comes to a point at a relatively short distance from lens 205. Those of ordinary skill in the related art will appreciate that the optimal numerical aperture of lens 205 may vary depending on various characteristics of scanner 110, probe array 140, assays, and other related characteristics. Also, in some embodiments it may be desirable to employ a low numerical aperture lens or other optical elements that may allow for a wide field of view at a desired focal plane. For example, some detectors such as for instance CCD type detectors may be enabled to collect signal information from the entire area, or substantial proportion thereof, of probe array 140. In the present example, optical elements that provide a wide field of view for the CCD detector may be employed and benefit from the advantages of the presently described invention.

FIG. 2B provides an illustrative example of a magnified view of the probe array of FIG. 2A showing a plurality of probes 220 disposed upon substrate 215 and an example of a target molecule hybridized to an embodiment of probe 220, illustrated as probe/target pair 225 that also includes associated label 228. FIG. 2B also illustrates excitation beam 240 that in some embodiments may be focused by objective lens 205 toward probe array 140 in a conical shape defined by focus/collection area boundary 210. For example, excitation beam 240 includes a plurality of photons of light of a particular wavelength that for instance may include a wavelength of 532 nm or other optimal wavelength that is within the range of excitation wavelengths that is characteristic of label 228. In the present example, label 228 includes a detectable label such as a fluorescent label commonly known to those of ordinary skill in the related art. For instance, fluorescent labels may include labels such as Cy3, Cy5, Alexa, R-Phycoerythrin, Fluorescein, Energy Transfer dyes (referred to as FRET dyes), or other type of dye known to those in the art. Other labels could also include semiconductor nanocrystals, also referred to as quantum dots, chemiluminescent, phosphorescent, luminescent, or other types of detectable light emitting label. Continuing with the present example, label 228 absorbs photons from excitation beam 240 and emits light of a longer wavelength in response. Those of ordinary skill in the related art will appreciate that the number of photons of light emitted from label 228 is related to the quantum efficiency of label 228 for the wavelength of beam 240, as well as being dependant on the level of power of beam 240. As illustrated in FIG. 2B, label 228 emits light in a spherical pattern (shown as emitted light 230), a portion of which is within focus/collection area boundary 210 and directed towards objective lens 205.

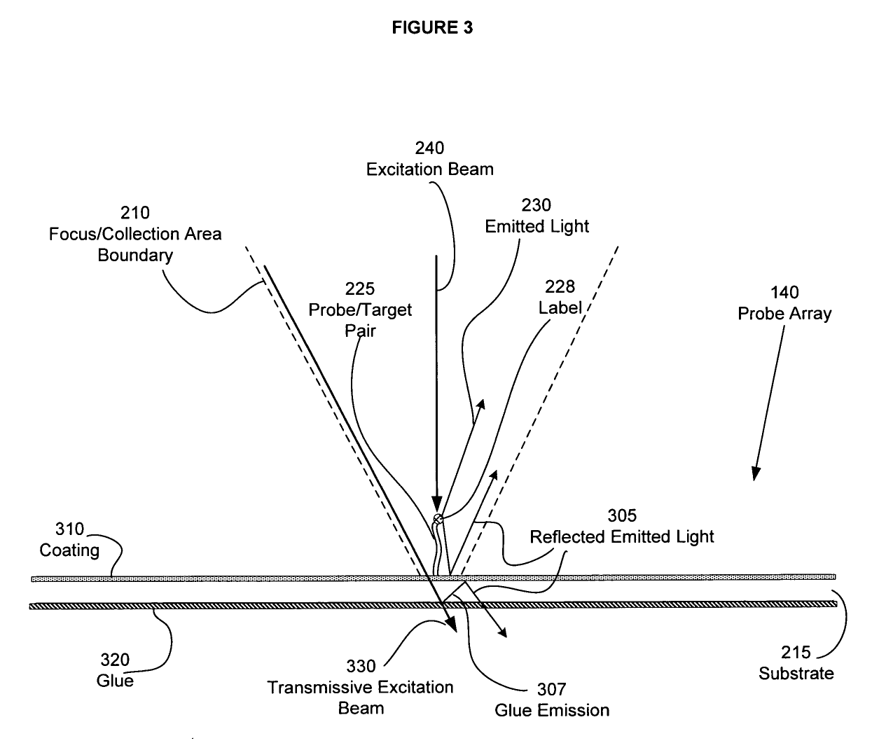

Coating 310: FIG. 3 presents an illustrative example of one embodiment of the presently described invention. Some embodiments of probe array 140 may include coating 310. Coating 310 may be applied to substrate 215 by a variety of methods known to those of ordinary skill in the related art, such as, for instance, vapor deposition, spin coating, or other types of spray techniques, non-spray techniques, and electrostatic techniques. Those of ordinary skill in the related art will appreciate that coating 310 may comprise a plurality of layers, where each layer may confer one or more characteristics to coating 310. For example, coating 310 may be applied to substrate 215 in one or more application steps prior to deposition or synthesis of probes 220. Additionally, coating 310 may be applied to the surface of substrate comprising probes 220 and probe/target pairs 225 as illustrated in FIG. 3, or alternatively coating 310 may be applied to the surface of the substrate opposite of probes 220. For example, coating 310 may be substantially absorptive to one or more ranges of wavelengths such as, for instance, a wavelength range that includes the wavelength of excitation beam 240 and/or a wavelength of emission beam 230. In the present example, coating 310 may be enabled to substantially reduce noise effects created by reflected or out of focus light.

Some embodiments of coating 310 are substantially reflective to a range of wavelengths of light emitted by label 228. For example, in addition to the fraction of emitted light 230 directed within boundary 210, a second fraction of the spherical pattern of emitted light 230 is directed towards substrate 215. Some or all of the second fraction is reflected by coating 310 of which a third portion of the second fraction is directed within boundary 210 towards objective lens 205, illustrated as reflected emitted light 305. Therefore the number of photons associated with the emitted light 230 from label 228 collected by one or more detectors of scanner 110 include the first and third fractions (i.e. reflected emitted light 305) of emitted light 230 and are additive. Thus providing for an improvement of the efficiency of collection of signal in some cases by up to a factor of two. In the present example, coating 310 may reflect 95% or more of emitted light 230 that may be within a particular range of wavelengths such as, for instance wavelengths at or above 550 nM.

In the same or other embodiments, coating 310 may also be substantially transmissive to wavelengths of light outside of the range of emitted light 230, such as, for instance the wavelength of excitation beam 240. For example, excitation beam 240 may be reflected back towards objective lens 205 because of various optical factors such as the reflectance of substrate 215, angle of incidence of beam 240 with substrate 215, or other factors known to those of ordinary skill in the related art, where the reflected excitation beam 240 may be collected by one or more detectors of scanner 110 and can be a significant source of what is referred to as noise in the resulting data. Those of ordinary skill in the related art will appreciate that noise can be very problematic in data interpretation and may obscure data associated with signals from emitted light 230. Therefore, it is desirable in many applications that excitation beam 240 pass through coating 310 that is substantially transmissive such as, for instance, transmitting 90% or more of beam 240 through coating 310 at a range of particular wavelengths that may include a wavelength of 532 nM, illustrated in FIG. 3 as transmissive excitation beam 330.

Alternatively, in some embodiments it may be desirable for coating 310 or substrate 215 to be substantially reflective to excitation beam 240. For example, substrate 215 may be substantially reflective of excitation beam 240 and emitted light 230 without the requirement for coating 310, where one or more elements of scanner 110, such as for instance on or more filters, reject the reflected light from excitation beam 240 prior to reaching one or more detectors, where the benefit from the amplified signal from emitted light 230 is realized without the undesirable noise effects from excitation beam 240.

In the same or other embodiments, substrate 215 of probe array 140 may be affixed to a surface, such as a peg, post, pillar, housing, cartridge, or other type of solid or flexible feature using glue, welds, mechanical features, or other means for affixing known in the art. For example, those of ordinary skill in the related art will appreciate that some types of glue, plastics, and other materials possess fluorescent characteristics. Also, bubbles or other inconsistencies may be present due to imperfections in deposition of materials, viscosity, or other reasons, that may cause light to be reflected, emitted, or otherwise transmitted towards lens 205. In the present example, in particular with respect to embodiments where coating 310 is substantially transmissive to beam 240, transmissive excitation beam 330 may provide excitation light for that is within an excitation range of the fluorescent characteristics of glue 320 and subsequently produces glue emission 307. In the present example, coating 310 is substantially reflective to glue emission 307, thus diverting light, illustrated as reflected emitted light 305, away from objective lens 205 thus reducing the background noise effects from glue emissions or other wavelengths within the range of wavelengths at which coating 310 is substantially reflective.

Alternatively, some embodiments of coating 310 are neither transmissive nor reflective but rather absorb light in a range of wavelengths such as, for example, the wavelength of excitation beam 240, thereby reducing the contribution of background noise to the detected signal.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments.

Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation. Also, the sequencing of functions or portions of functions generally may be altered. Certain functional elements, files, data structures, and so on may be described in the illustrated embodiments as located in system memory of a particular computer. In other embodiments, however, they may be located on, or distributed across, computer systems or other platforms that are co-located and/or remote from each other. Numerous other embodiments, and modifications thereof, are contemplated as falling within the scope of the present invention as defined by appended claims and equivalents thereto.

1. A probe array product, comprising:
a substrate comprising a plurality of biological probes disposed thereon, wherein at least one of the biological probes is enabled to hybridize a target molecule that comprises a detectable label; and
a coating disposed upon a first surface of the substrate, wherein the coating is substantially reflective at a first wavelength range and is substantially transmissive at a second wavelength range.

2. The probe array product of claim 1, wherein:
the plurality of biological probes are disposed on the first surface, wherein the coating is disposed between the substrate and the biological probes.

3. The probe array product of claim 1, wherein:
the detectable label emits a first wavelength within the first wavelength range in response to a second wavelength in the second wavelength range.

4. The probe array product of claim 3, further comprising:
one or more optical elements that collect a first fraction and a second fraction of the first wavelength, wherein the first fraction is emitted within a collection area of at least one of the optical elements and the second fraction is emitted and reflected into the collection area.

5. The probe array product of claim 4, further comprising:
one or more detectors optically coupled to the one or more optical elements that produce a detected signal responsive to the collected first and second fractions of the first wavelength.

6. The probe array product of claim 5, wherein:
the second fraction provides an increase of the detected signal from the first wavelength of up to a factor of two over the first fraction alone.

7. The probe array product of claim 5, wherein:
the coating transmits substantially all of the second wavelength away from the collection area of the one or more optical elements, wherein the detected signal is substantially free of the second wavelength.

8. The probe array product of claim 5, wherein:
the coating reflects substantially all of a third wavelength away from the collection area of the one or more optical elements, wherein the detected signal is substantially free of the third wavelength.

9. The probe array product of claim 8, wherein:
the third wavelength comprises emission from the group consisting of, glue, plastic, one or more bubbles, and material imperfections.

10. The probe array product of claim 1, wherein:
the coating is 95% reflective in the first wavelength range.

11. The probe array product of claim 1, wherein:
the first wavelength range comprises a range of wavelengths 550 nm or greater.

12. The probe array product of claim 1, wherein:
the coating is 90% transmissive in the second wavelength range.

13. A system for increased signal detection, comprising:
a substrate comprising a plurality of biological probes disposed thereon, wherein at least one of the biological probes is enabled to hybridize a target molecule that comprises a detectable label that emits a first wavelength in response to a second wavelength;
a coating disposed upon a first surface of the substrate, wherein the coating is substantially reflective at a first wavelength range and is substantially transmissive at a second wavelength range; and
a scanner comprising:
a source that provides the second wavelength;
one or more optical elements that collect a first and a second fraction of the first wavelength; and
one or more detectors optically coupled to the one or more optical elements that produce a detected signal responsive to the collected first and second fractions of the first wavelength, wherein the second fraction provides an increase of the detected signal from the first wavelength.

14. The system of claim 13, wherein:
the first wavelength is within the first wavelength range and the second wavelength is within the second wavelength range.

15. The system of claim 13, wherein:
the first fraction is emitted within a collection area of at least one of the optical elements and the second fraction is emitted and reflected into the collection area.

16. The system of claim 13, wherein:
the second fraction provides an increase of the detected signal from the first wavelength of up to a factor of two over the first fraction alone.

17. A method for increased signal detection, comprising:
directing a first wavelength at a detectable label that emits a second wavelength in response to the first wavelength;
transmitting the first wavelength away from a collection area;
reflecting a first fraction of the second wavelength into the collection area;
collecting the first fraction and a second fraction of the second wavelength from the collection area, wherein the second fraction comprises emission within the collection area; and
producing a detected signal responsive to the collected first and second fractions, wherein the first fraction provides an increased magnitude of the detected signal.

18. The method of claim 17, wherein:
the first wavelength is within the first wavelength range and the second wavelength is within the second wavelength range.

19. The method of claim 18, wherein:
the step of transmitting further comprises transmitting substantially all wavelengths within the first wavelength range.

20. The method of claim 18, wherein:
the step of reflecting further comprises reflecting substantially all wavelengths within the second wavelength range.

21. The method of claim 17, wherein:
the detected signal is substantially free of the first wavelength.
